(19) United States
(12) Patent Application Publication
(10) Pub. No.: US 2021/0297039 A1
(43) Pub. Date: Sep. 23, 2021

(54) Retroreflector method to prevent light pollution without energy absorption

(71) Applicant: David W. Urry, San Rafael, CA (US)

(72) Inventor: David W. Urry, San Rafael, CA (US)

(73) Assignee: David W. Urry, San Rafael, CA (US)

(21) Appl. No.: 16/822,001

(22) Filed: Mar. 17, 2020

(51) Int. Cl. H02S 40/22; F21V 7/00; F21V 14/04

(52) U.S. Cl. CPC H02S 40/22; F21V 14/04; F21V 7/0041

(57) ABSTRACT

This patent advances a technique for the use of retroreflectors to prevent light pollution while radiating electromagnetic energy away from an object. As such, the patent defines how to do this on a surface, on a solar panel and with a communication device. It further investigates the communication device and makes it useful for relatively ad-hoc communication systems where aspects of the source and destination locations, distances, orientations and detection equipment is not known ahead of time.

### BACKGROUND

One of the simplest Apollo moon experiments has been one of the most successful. A purpose built passive array of mirrors, called retroreflectors, on the moon called the The Lunar Laser Ranging Experiment. The Lunar Laser Ranging Experiment uses no energy and has been giving us exact locations of the moon since Jul. 21, 1969. This patent advances that idea to use an array of retroreflectors to reduce light pollution while reflecting radiant energy away from structures. Non-light polluting retroreflectors then become a way of passively allowing solar panels to reduce albedo, and the creation identification, orientation and communication systems that are also non-light polluting.

Retroreflector: any device or surface that reflects electromagnetic radiation back to its source irrespective of the angle the radiation hits the surface. There are several types of retroreflectors:

A corner retroreflector uses 3 perpendicular reflective surfaces (see image 1).

A cat's eye retroreflector uses a refractive element and a reflective surface, The reflective surface is positioned to exactly compensate for the refraction of the refractive element. There are other retroreflectors that are considerably more complex.

Light in the context of this document refers to any form of electromagnetic radiation and is not limited to visible light. Non-light polluting refers to the absence of electromagnetic radiation emanating from a particular location relative to an observer's location.

Satellite: an artificial body placed in orbit around a celestial object.

Satellites, because they exist in the harsh environment of space, have specific requirements to absorb or reflect energy to control heat, expansion and other physical, mechanical and electrical processes within the satellite.

Reflected/refracted light pollution is caused when the course of light waves are changed from their current direction to a new direction. The change in direction of light waves, regardless of reflection or refraction, is light pollution when the light is interacting with man made objects. Light pollution creates light or an image in what would otherwise be a dark field.

Light pollution may destroy scientific observations as well as generally destroying the night sky. As such, large satellite installations currently going into production threaten to destroy our ability to observe the physical universe.

Surfaces with low albedo tend to absorb energy while services with high albedo tend to cause light pollution. The moon reflects 12% of the sun's energy it receives which is another way of saying that it absorbs 88% of the sun's energy it receives. Another way of looking at this is that the moon has the same reflectivity as an asphalt parking lot. As we've all seen an asphalt parking lot on a sunny day and realize that that's a very hot environment—after the sun's light has come through about 60 miles of atmosphere and lost about 15% of its radiant energy.

Outside the atmosphere in direct sunlight, the problem with satellites needing to control their thermal environment is a difficult one. In space, the surface of an object can transition from extreme cold to extreme heat very quickly.

Solar panels are also a major source of light pollution. And combination of a solar panel with a retroreflector design to prevent light pollution is a non-obvious improvement on an existing solar panel design. This is an improvement on WO2007148325A2 for the purpose of preventing light pollution (https://patents.google.com/patent/WO2007148325A2/en).

The term “retroreflector” has been used to send a signal from a specific source to a specific destination in what is a two dimensional configuration (US2002018649A1 https://patents.google.com/patent/US20020186449A1/en?oq=20020186449). This document uses the term “retroreflector” to send light back to its destination with 3 degreeses of movement at the source and at the destination. This is an important distinction as it allows both source and destination a significant amount of movement.

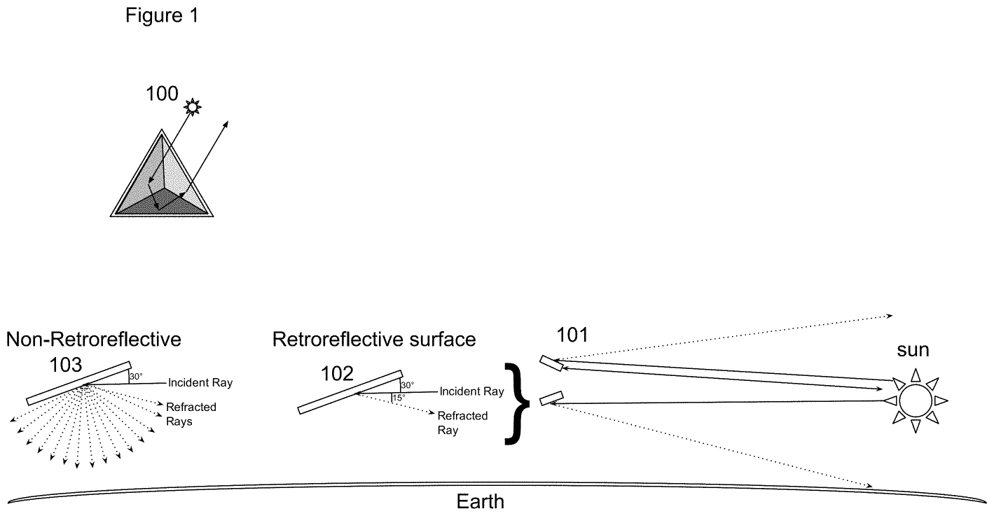

https://patents.google.com/patent/US20110128625A1 defines a modulating retroreflector without concern for light pollution as defined herein. A retroreflector that reduces light pollution must have a surface that does not refract light beyond 45 degrees when light enters it at a glancing angle. The flat or irregular surfaces described in US20110128625A1 have potential reflected angles of greater than 150° in cases where light hits the retroreflector glancing angles of incident. See FIG. 1 103 for an example of what happens with the retroreflectors described in US20110128625A1 at high degree of incidents. Furthermore, flat or irregular surfaces may interact unpredictably with other light sources (like sunlight) to render them unusable during large portions of its operational life. For example, the devices described in US20110128625A1, if exposed to sunlight will likely be unusable as the sunlight will overpower any light source with an incident ray at greater than 45° of the sun incident array. Finally, the modulating surface must accomplish reflecting radiation at all times otherwise the absorbed radiation (which may be significantly in excess of the radiation hitting the device from the intended receiver) may defeat the need of the object to radiate energy. As such, the retroreflectors described herein accomplish a more specific task and represent a novel invention not accounted for or described by US20110128625A1.

### SUMMARY OF THE INVENTION

Retroreflectors reflect light directly back at their source, as such, they do not create light pollution where light is reflected from a source in a new direction. By reflecting light back to its source, retroreflectors create a solution for satellites that do not absorb the light and do not create light pollution.

The same retroreflector technique can also be used for solar panels because while they are intended to absorb light, any flat surface will create light pollution by reflecting light in undesirable directions. By changing a solar panel to a three dimensional retroreflector the solar panel has 3 opportunities to absorb radiant energy and has the opportunity to send the remaining radiant energy back toward its origin rather than creating glare and light pollution.

Modifying a retroreflective surface dramatically changes the direction of light traveled over distance. Modifying one surface by 1/10 of one degree results in almost 10 feet per mile. So, putting a slight modification in a series of retroreflectors can be used to identify an object and tell its speed, and orientation across all three axis of direction. This is done by illuminating the object with a laser and viewing the reflected light as points of light from each reflector. Repeating the process a moment later shows movement and based on the relative lengths of the two patterns, can show yaw, pitch and roll of the object over time.

Many traffic road signs use retroreflectors, and the orientation, size and content of a road sign is determinable in this method.

By creating an array of retroreflectors with the ability to offset them by a slight amount, the object can hold tags that positively identify it and it's locational and motion vectors.

By creating an array of retroreflectors, each of which can move a slight amount, the retroreflectors become a massive array of information that can be communicated across vast distances without the use of onboard power to send a signal across the great distance.

By using corner retroreflectors and modifying one side, the retroreflector can either send light back to the source or a slightly modified direction. By not sending light directly back to the source, a reading laser will see the signal as either on (reflected back) or off (reflected away from the source). Over distances exceeding 100 meters, only one of the three corner retroreflector mirrors need be modified only slightly to produce the “off” effect.

By grouping retroreflectors in the array into signal groups, the retroreflective array can display a large number of simultaneous bits of information or a smaller number of grouped retroreflectors can display fewer bits of information in a format that can be read from a greater distance. For example, a corner retroreflector can display a single on/off byte in the shape of a triangle. Two retroreflectors could combine to display a single on/off byte in the shape of a diamond. Six retroreflectors could combine to display a single on/off byte in the shape of a hexagon.

Eighteen could combine to display a single on/off byte in the shape of a larger hexagon.

The speed of the retroreflector mirror transition as well as the size of the retroreflector bank in array can be modified to accommodate the receiver's exposure rate

### DRAWINGS

### Brief Description of Drawings

FIG. 1 depicts one of several types of retroreflector that reflects electromagnetic radiation from a large degree of angles, directly back at the source of electromagnetic radiation 100. The image of a light source and arrows represent the hypothetical path of a photon of light as it reflects off the three reflective surfaces. It is inherently difficult to visualize a retroreflector because retroreflectors do not cast shadows. Shadowing, however, is useful to help human visualization of the drawings. The image drawn is deep in the middle and the outer edge (white) is the high point.

FIG. 1 201 shows what happens if a retroreflective surface is inclined at a low angle to the incident ray.

FIG. 1 102 shows what happens when a retroreflector is used beyond its retroreflective design capacity and as noted it still maintains an important function for preventing or reducing light pollution.

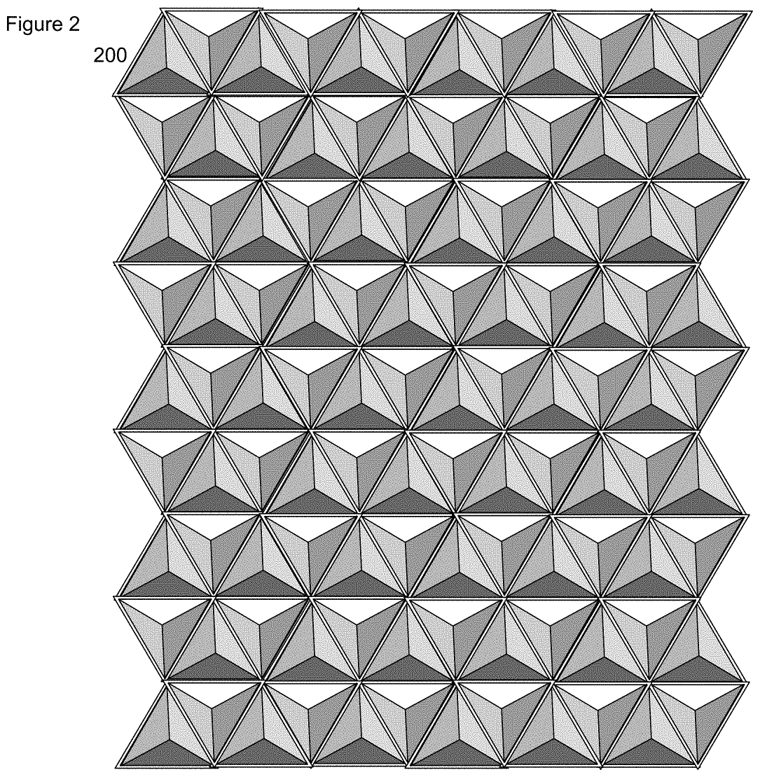

FIG. 2 depicts an array of retroreflectors 200.

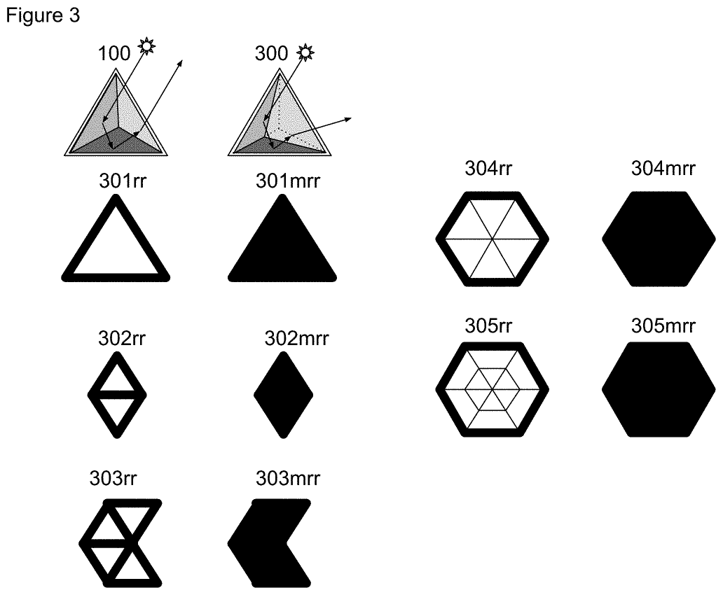

FIG. 3 depicts a standard retroreflector 100 and a modified retroreflector 300. Retroreflectors and modified retroreflectors can be scaled to any size depending on the needs of the array measurement system. A non-exhaustive set of retroreflectors and modulated retroreflectors used to demonstrate this concept of scaling the image pixel 301rr-305rr and 301mrr-305mrr. Each pixel is capable of rendering essentially one bit of information as on/light or off/dark bit. 302rr demonstrates a bank of two reflectors and 302mrr demonstrates a bank of two modulated retroreflectors. 303rr demonstrates a bank of four reflectors and 303mrr demonstrates a bank of four modulated retroreflectors. 304rr demonstrates a bank of six reflectors and 304mrr demonstrates a bank of six modulated retroreflectors. 305rr demonstrates a bank of 18 reflectors and 305mrr demonstrates a bank of 18 modulated retroreflectors.

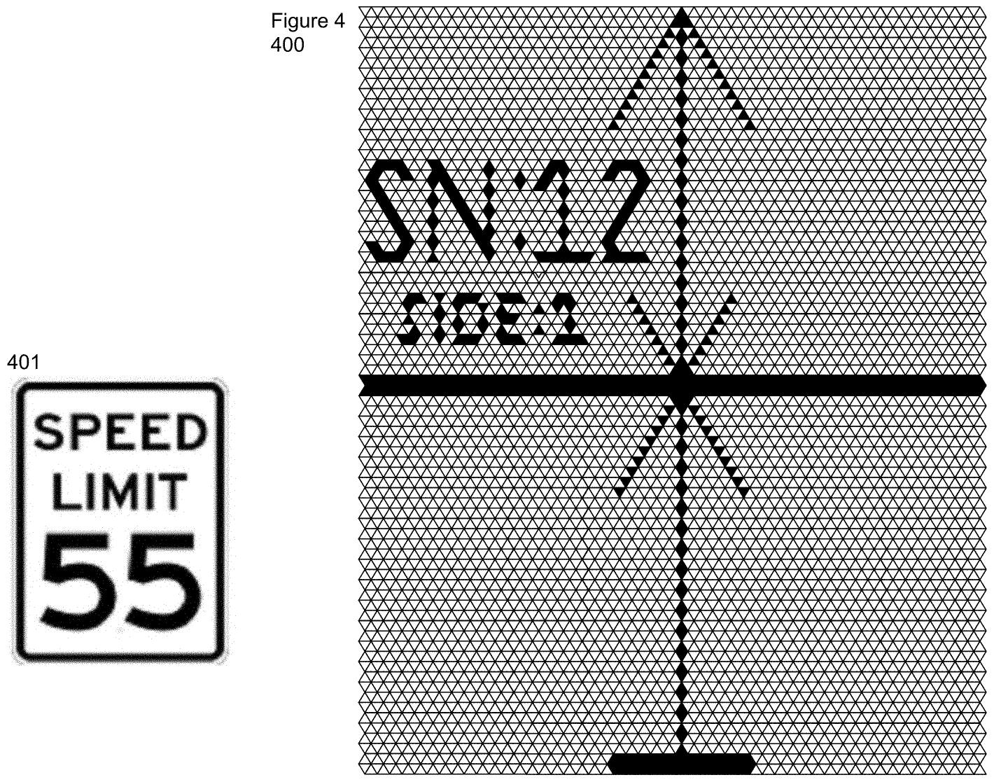

FIG. 4 depicts a retroreflector array 400 with modulated retroreflectors in it. Retroreflectors can be used individually or in groups to produce a series of measurements when the array is analyzed. Retroreflectors can be configured in groups to produce larger symbols that can give the distance to the object as well as orientation of the object to the source in terms of pitch and yaw.

FIG. 4, 401 demonstrates an array of retroreflectors used to identify a traffic sign.

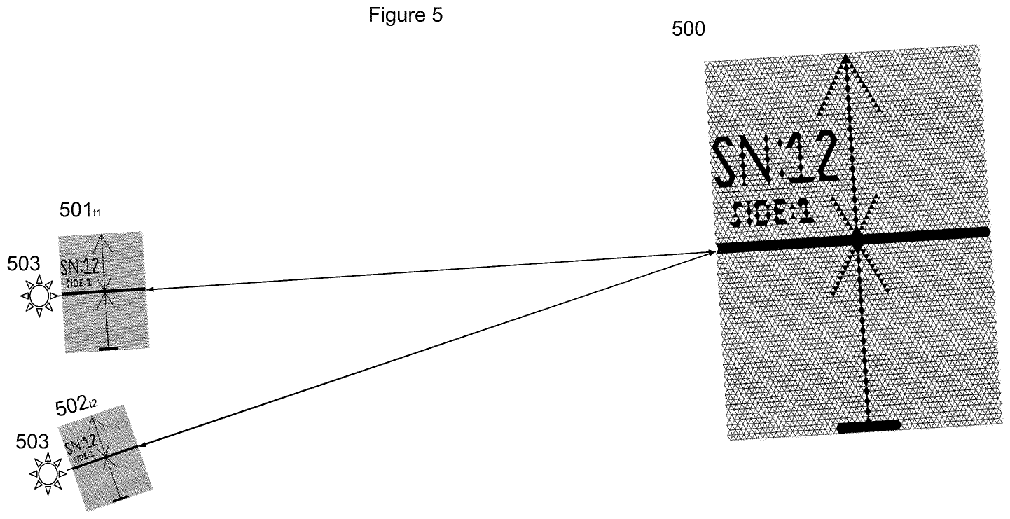

FIG. 5 depicts a retroreflector array 500 (presumably attached to an un-drawn object. A light source 503 illuminates that object producing an array of measurements 501. The 501 measurements then gives the distance from the light source to the detector device as well as the X,Y & Z coordinates (pitch, yaw and rotation) of the retroreflector plane based on the relative length and width of lines in the plane. Taking a separate reading separated by time or distance 502 allows for the calculation of pitch, yaw, rotation and direction as vectors of movement in each of these parameters. The example in FIG. 5 does not depict all possible retroreflectors, all possible means of sampling a retroreflector, or all possible means of modifying a retroreflector.

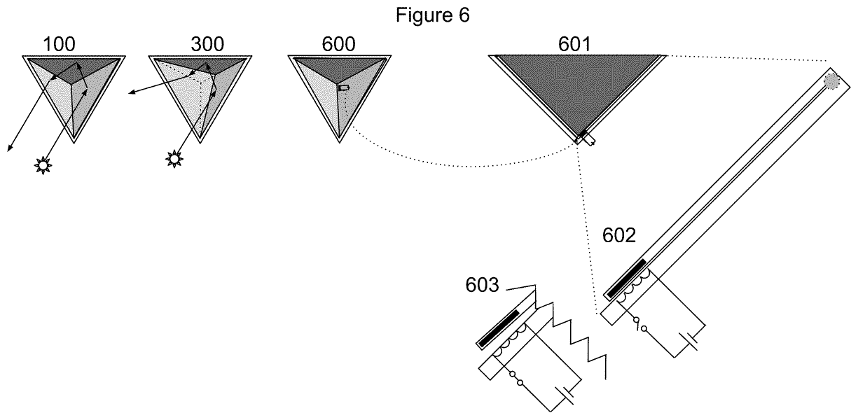

FIG. 6 describes a mechanism for turning a three dimensional retroreflector into a modulated three dimensional retroreflector. A small magnet is embedded into the back of one of the three retroreflector mirrors. An electromagnet with a power source and a switch is provided 601. An expanded view of the retroreflector mirror, magnet, electromagnet and related equipment is provided 602. When the electromagnet is in one state (via the switch) the magnet closes the mirror 602 making device 600 a standard retroreflector. When the electromagnet state changes the mirror is moved 603 making device 600 a modulated retroreflector. The condition of the switch (off being state 602 and on being state 603 is immaterial—conditions may be reversed depending on need).

Figure 600 can be placed in an array of thousands of identical retroreflectors. Creating thousands of simultaneous “channels” of communication. Groups of 600s can be combined to create the effect of a larger signal as described in FIG. 301rr-305rr and 301mrr-305mrr in real time depending on momentary system needs, sensor equipment available and the like.

### DETAILED DESCRIPTION OF THE PREFERRED EMBODIMENT

The current embodiment uses a corner retroreflector to prevent light pollution while preventing undesired absorption on surfaces of an object including the body of the object, solar panels of the object and communication equipment of the object. The use of static modulated retroreflectors (SMRRs) can also be used to label the object so that a remote sensor can identify the object, determine its orientation in space and apply vectors to this orientation. Arrays of Active MRRs (AMRRs) can be used to communicate with remote systems without creating surfaces that create light pollution or absorption. AMRRs can also communicate between multiple sources simultaneously as each light source that hits it will cause it to return the same signal. Arrays of AMRRs can be divided up into banks of AMRR. AMRR banks can all operate in a synchronized way creating a larger signal. This signal can be modulated in amplitude (by adding more AMRRs to the bank) or frequency (by changing the switching rate). Amplitude and frequency can both be used in different arrangements simultaneously in the same AMRR array creating a series of simultaneous channels. Each of which can be tuned specific receivers based on distance, orientation, detection capabilities and the like.

### Retroreflectors

A corner retroreflector is used in the current embodiment (FIG. 1 100) but is not exhaustive of retroreflector options. A retroreflector array with a surface perpendicular to the light source will send the light source back to its origin (FIG. 2 200). The incident ray hitting the reflector is bounced back in the exact opposite direction. So, an incident ray hitting the surface at 0° to 45° returns a reflected ray back at 0° to 45° (in all three axes). As important has getting a reflected ray back at the same angle as the incident ray between 0° to 45° is what happens beyond 45° (FIG. 1 102). At greater than 45°, the reflected ray follows this formula: for 90°>Incident Ray>45° reflected ray=Incident Ray−45°. This formula, which shows what happens when a retroreflector ‘fails’ to return light to it source shows that the retroreflector tends to return light in the direction of the source. In the case of atmospheric light pollution, this tends to send sun or moon light back to the location that is already affected by the light source instead of sending light to new, unaffected, areas. The full formula is as follows:

For 0°>=incident ray>=45° reflected ray=|incident ray|+180°

For 45°>45 incident ray>=90° reflected ray=|incident ray|+130°

For Incident Ray>90° incident ray does not hit surface

With the embodiment of corner reflectors, the reflected beam has three components. The X access being the incident ray, the Y axis being the reflected ray, in the z access there will be three distinct rays. The sum of the three rays will diverge as much as 45° from the incident ray normal. reflected ray's composition will be in three parts with the sum of the three reflected rays being the inverse of the incident ray (but on the Z access with the previously stated divergence) and the power of any given ray approaching zero as the angle approaches 90°.

FIG. 1 102 demonstrates that a slight inclination of a retroreflective array can make it non-observable from an earth based detector—thus eliminating earth based light pollution. Or, if such an inclination is not desirable, puts the light pollution in an area already affected by the primary light source.

The impact of high angle of incidence light reflection on light pollution is very important for two reasons: Retroreflectors keep the footprint of the light pollution small and direct it at areas already affected by the primary light source.

### Modified Retroreflectors

The static modified retroreflector (FIG. 3 300) slightly adjusts one reflection of the retroreflector to send light away from its origin. This still prevents light absorption while minimizing light pollution, however, the resulting mathematical array of points derived from the retroreflector array reveals identity and orientation information about the array. Combining mathematical arrays of points separated by time or distance can add vectors including pitch, yaw, roll and speed of the array as each point in the array can have a calculated distance from the sensor.

In the preferred embodiment, the modified retroreflector (FIG. 3 300) angles one of the three mirrors slightly to prevent light from traveling back directly to its source. While this angle is dramatic in FIG. 3 300 for didactic purposes, an angle of one degree results in light being offset over 20 meters from its origin at a kilometer. So, the degree change need only be extremely slight (1/1000 of a degree per 50 kilometers) but the final angles depend on imaging aperture and other factors.

Modified retroreflector are automated to produce modulating retroreflector (MRR) (Image 6 600, 601, 602, 603) and take advantage of groups of MRRs as well as the modulation rate to communicate with multiple destinations with different signal requirements.

### Solar Panels

Solar panels, while generally are designed to have low albedos and design parameters, their smooth covering as well as intense light environments tend to contribute to light pollution. As such, using a retroreflector design eliminates this light pollution, particularly when the solar array is pointed directly at a light source. The technique is pictured in FIG. 2 with solar cells being placed in front of the reflective mirrored surface. Reflecting the energy that would normally become heat in the substructure of the solar cell also improves solar cell efficiency so the same strategy of reflecting energy rather than absorbing it applies here as well.

### Modulated Retroreflector Arrays

Communicating with retroreflectors is not a new concept. However, using an array of retroreflectors as a multi-channel, scalable system with variable modulation frequency is. By taking bank or subset of retroreflectors within the larger array and having them all respond simultaneously in real time to form a larger image allows the retroreflector to be configured during use for simultaneous communication with multiple information receivers. This is particularly important when you consider that a modulating retroreflector of indium gallium arsenide and aluminum gallium arsenide grown in a crystal to form a 5 millimeter retroreflector may be too small to detect from significant distance. However, a bank of 10, 100 or 1000 of these acting in unison as a single channel in a larger array are detectable over exponentially larger distances.

Retroreflector communication arrays (RCA) have the following characteristics. The active part of the communication system does not contribute to light pollution, reflects energy from the craft, and allows multiple remote locations to receive communication simultaneously. The RCA can be scaled during operation so that different receivers in mobile locations and operating environments can receive different channels.

1. A method for reflecting electromagnetic radiation off a surface which minimizes light pollution and minimizes electromagnetic radiation absorption by covering a surface with retroreflectors including the use of an array of retroreflectors with the surface edges aligned on a plain.

2. A retroreflector as described in claim one, some of the retroreflectors in the array being modified slightly to direct light a fraction of a degree away from its source.

3. A retroreflector as described in claim one coupled with a sensor system to determine the distance of one part of the array from another part of the array thus determining the distance and orientation of a surface including multiple reading of the sensor system separated by time to determine all axis of movement of the retro reflective surface.

4. A retroreflector as described in claim two with a sensor system to determine the pattern of light emanating from the retroreflectors.

5. A retroreflector as described in claim one made with an additional layer of photo receptors (solar panels) to convert light into electricity without creating a flat surface resulting in light pollution while not absorbing excess energy as heat.

6. A retroreflector as described in claim 1 with an active retroreflector array, each retroreflector of which is capable of modifying itself based on the instruction of a central processing unit such that the entire array can communicate as a series of independent entities which may be coordinated into groups that operate in unison to form groups of independent entities, each retroreflector or group being capable of a completely independent communication.

7. A retroreflector as described in claim 1 made out of a solid sheet of metal with retroreflectors carved into it, producing a light weight, strong, anti glare surface.
